(19) United States
(12) Patent Application Publication
(10) Pub. No.: US 2003/0155486 A1
(43) Pub. Date: Aug. 21, 2003

(54) Method and apparatus for co-axial alignment through non-coaxial means

(75) Inventors: Frankie Rogers, Gaithersburg, MD (US); Anthony W. Yu, Spencerville, MD (US); James Sung Cho, Columbia, MD (US); Stewart Wayne Wilson, Silver Spring, MD (US)

Correspondence Address: FOLEY AND LARDNER, SUITE 500, 3000 K STREET NW, WASHINGTON, DC, 20007, US

(73) Assignee: QUANTUM PHOTONICS

(21) Appl. No.: 10/208,744

(22) Filed: Aug. 1, 2002

Related U.S. Application Data
(60) Provisional application No. 60/356,776, filed on Feb. 15, 2002.

(51) Int. Cl. H01J 3/14

(52) U.S. Cl. 250/216; 372/92

(57) ABSTRACT

An optical alignment device is provided comprising a base portion extending the length of the alignment device, a substantially horizontal package mounting portion coupled to the base portion, and a component retaining portion coupled to the base portion.

### CROSS REFERENCE TO RELATED APPLICATION

The present application claims priority to and the benefit of the following U.S. Provisional Patent Application:

Serial No. 60/356,776 filed Feb. 15, 2002

The foregoing provisional application is incorporated by reference herein in its entirety.

### BACKGROUND OF THE INVENTION

A. Field of the Invention

The invention is directed to optical component attachment methods and apparatuses, and more particularly, to an apparatus to support optical component(s) attachment to packages that traditionally require a coaxial attachment system.

B. Background of the Invention

Coaxial alignment and attachment of an optical component to a package is typically performed with a symmetrically placed beam system such that each beam is equally positioned about a coaxial center. Namely, a three-beam system at minimum is generally needed to achieve this. Special tooling such as coaxial alignment stage, grippers and special fixtures are required for coaxial attachment to properly align three-beam systems and attach the components to the package, due to the heightened need for access to an even point about the coaxial center. A two-beam system is typically configured such that the beams are 180° apart. This is usually employed if only the top half of the device is accessible for assembly. A three beam system is configured such that the beams are 120° apart. A three beam system is used when the device being assembled has access all around. This requires the system to position the package upright, and requires a complex system of tooling and fixtures. Furthermore, this process also does not lend well to post attachment alignment.

Alignment and attachment of optical components to packages such as a butterfly style require a two beam system (if laser welding is emphasized) with two dispensers (if epoxy is employed) in a single side (e.g., top-down) configuration. Top-down is generally the only way to have unobtrusive view of the inside of the package or device being assembled. This is the conventional way to align optical components inside a butterfly package. A horseshoe or equivalently shaped clip is typically used to secure the optical components to the package. This requires the use of additional tooling to hold the clip in place, to ensure that it is seated, and in contact with the surface that it is being attached to.

### SUMMARY OF THE INVENTION

According to one aspect of the present invention, an optical alignment device is provided comprising a base portion extending the length of the alignment device, a substantially horizontal package mounting portion coupled to the base portion, and a component retaining portion coupled to the base portion.

According to another aspect of the present invention, the component retaining portion is substantially vertical with respect to the substantially horizontal package mounting portion.

According to another aspect of the present invention, the substantially horizontal package mounting portion comprises a plurality of substantially horizontal feet, each of the feet extending substantially horizontally from a top edge of the base portion. Preferably, each of the substantially horizontal feet has a foot length in the range of about 0.5 mm to about 2 mm.

According to another aspect of the present invention, each of the substantially horizontal feet is formed by one of Electrical Discharge Machining (“EDM”), laser cutting, and stamping and press fitting. Most preferably, each of the substantially horizontal feet is formed by stamping and press fitting.

According to another aspect of the present invention, the substantially horizontal package mounting portion is attached to a package. Preferably, each of the substantially horizontal feet is attached to the package by one of welding, epoxy, and solder. Most preferably, each of the substantially horizontal feet is attached to the package by laser welding.

According to another aspect of the present invention, the component retaining portion comprises a plurality of side walls, each of the side walls extending from a top edge of the base portion. Preferably, each of the side walls has a height in the range of about 0.5 mm to about 2 mm.

According to another aspect of the present invention, the base portion has a substantially semicircular cross-section extending the length of the alignment device. Preferably, the base portion has a radius in the range of about 0.4 mm to about 2 mm.

According to another aspect of the present invention, the optical alignment device is made of a material comprising at least one of stainless steel, kovar, invar, and nickel. Preferably, the optical alignment device is made of nickel.

According to yet another aspect of the present invention, a method of coaxial alignment is provided comprising the steps of positioning an optical component in an optical alignment device, attaching a substantially horizontal package mounting portion to a package, and attaching the optical component to a vertical component retaining portion. The optical alignment device comprises a base portion extending the length of the alignment device, the substantially horizontal package mounting portion coupled to the base portion, and the substantially vertical component retaining portion coupled to the base portion.

According to another aspect of the present invention, the method further comprises a step of adjusting at least one of the position and alignment of the optical component within the optical alignment device after attaching the substantially horizontal package mounting portion to a package.

According to yet another aspect of the present invention, a coaxial alignment and attachment clip for single side optical component attachment is provided comprising a component loading section, and a package fixation section attached to the component loading section for fixing a package to the clip. The component loading section allows the optical component to be adjustable by at least one of: (1) rotationally about a central axis of the optical component; (2) slidably along a length of the optical component; and (3) slidably along a height of the optical component.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below and which constitute part of this specification.

FIG. 1 is a perspective view of an attachment clip according to an embodiment of the present invention.

FIG. 2a depicts a front view of an attachment clip according to an embodiment of the present invention.

FIG. 2b depicts a top view of an attachment clip according to an embodiment of the present invention.

FIG. 2c depicts a side view of an attachment clip according to an embodiment of the present invention.

FIG. 3 depicts a top view of an attachment clip with welding spots indicated according to an embodiment of the present invention.

FIG. 4 depicts a side view of an attachment clip with a vertical side wall indicated according to an embodiment of the present invention.

FIG. 5 depicts a perspective view of an attachment clip with vertical wall height b and horizontal feet height a according to an embodiment of the present invention.

FIG. 6 is a perspective view of an attachment clip according to an embodiment of the present invention.

### DETAILED DESCRIPTION OF PREFERRED EMBODIMENTS

Reference will now be made in detail to presently preferred embodiments of the invention. Wherever possible, the same reference numbers will be used throughout the drawings to refer to the same or like parts. Throughout the description, the term “component” will be used to describe any part which can be aligned using the alignment clip of the present invention. Preferably, a component includes an optical component, such as lenses and optical fibers. The present invention can also be used, however, to align a plurality of components (i.e., an assembly).

The inventors have discovered a novel attachment clip that can be used to hold an optical component and/or assembly. The novel design allows for coaxial attachment of components by using a more flexible and economical single side (e.g., top-down) attachment system. This attachment clip is suitable for active alignment and attachment of the optical assembly (or component). The attachment process may include, but is not limited to soldering, epoxying, and welding. The attachment clip allows for coaxial type alignment (i.e., along the axis of the clip) with a top-down configuration. Furthermore, the attachment clip allows for pressure to be applied by the optical assembly in order to make contact between a plurality of feet and a package, which may be necessary for some methods of attaching the feet to the package.

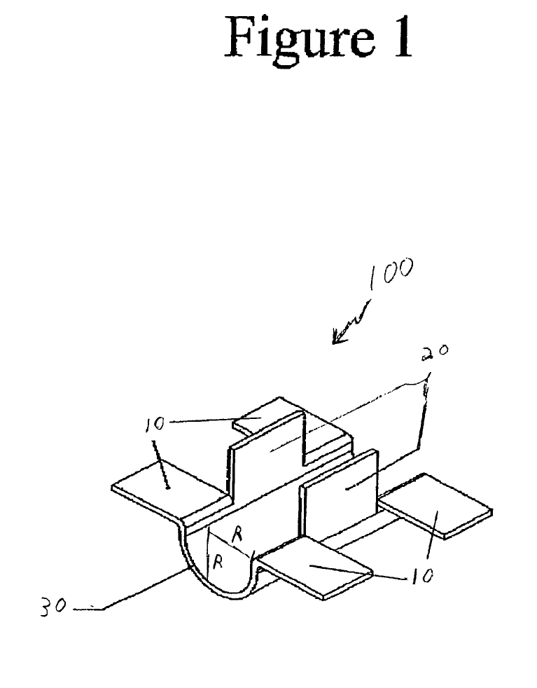

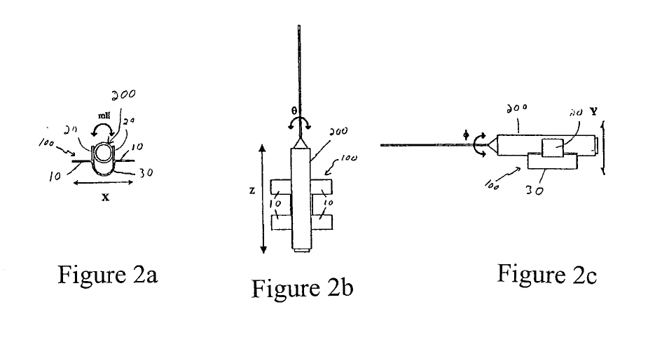

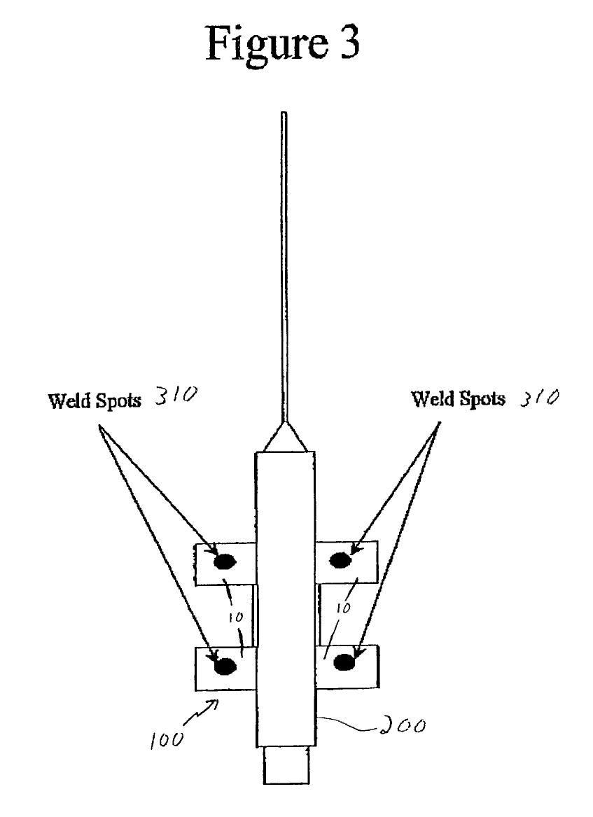

A first embodiment of an attachment clip 100 according to the present invention is shown in the views of FIGS. 1-5. The attachment clip 100 includes two or more substantially vertical side walls 20, a base portion 30, and a plurality of substantially horizontal feet 10. As shown in the various views of FIG. 2, the attachment clip 100 allows the optical component 200 to be manipulated in the: X and roll (FIG. 2a), Z and θ (FIG. 2b), Y and φ (FIG. 2c) directions and unlimited 360° roll. It should be appreciated that attachment of the clip 100 to the package sets the X and θ parameters. As shown in FIG. 3, the clip 100 is preferably attached to the package by laser welding 310 the substantially horizontal feet 10 to the package. However, as would be readily apparent to one of ordinary skill in the art after reading this disclosure, other attachment schemes are also possible.

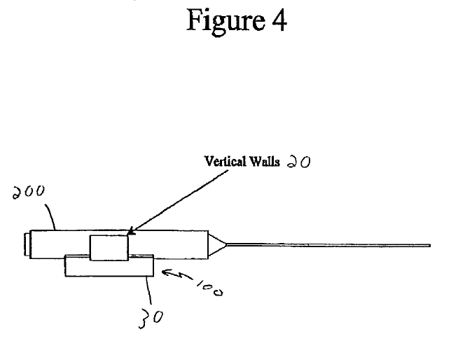

The Y, Z, φ, and roll parameters can typically still be adjusted even after the clip 100 is attached to the package. As shown in FIG. 4, the substantially vertical side walls 20 provides for increased allowable vertical translation of the optical component 200. The design of the attachment clip 100 is such that any shifting due to movement in the attachment process can be compensated for to regain optimal position and alignment.

The attachment clip 100 may be adjusted to accommodate various optical components 200 and/or assemblies. The attachment clip 100 may include any number of substantially horizontal feet 10 and substantially vertical side walls 20. It should also be appreciated that the substantially horizontal feet 10 are preferably horizontal, but may also be positioned at an angle if desired. Similarly, the substantially vertical side walls 20 are preferably vertical, but may also be angled inward or outward if desired.

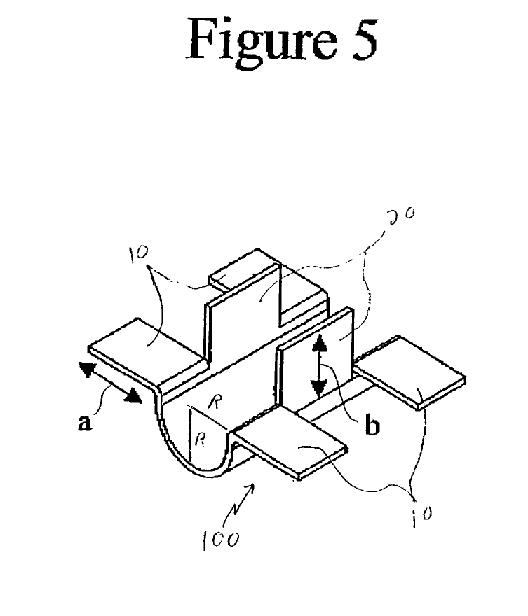

Furthermore, the clip 100 is not limited to circular components as shown in the Figures. The clip 100 as shown in FIG. 5 has a base portion 30 with a substantially circular cross-section with radius R. However, the cross-section could be rectangular or ovular in shape. As would be readily apparent to one of ordinary skill in the art after reading this disclosure, the feet dimension (a) and the vertical wall dimension (b) depicted in FIG. 5 can be adjusted in order to increase or decrease the absolute travel of the component. Thus, the dimensions a, b, and R may vary based on the size of the component 200 and the amount of travel desired. Preferably, the substantially horizontal feet 10 dimension a is in the range of about 0.5 mm to about 2 mm. Preferably, each of the substantially vertical side walls 20 has a height b in the range of about 0.5 mm to about 2 mm. Preferably, the base 30 has a radius in the range of about 0.4 mm to about 2 mm.

The attachment clip 100 can be used to hold an optical component 200. Once in the clip 100, the optical component 200 can be translated and/or rotated in order to find the optimal position. Once an optimal position is achieved, the optical component can be fixed to the clip 100. For example, the clip 100 and the optical component 200 could be laser welded in place. This would preferably utilize a two-beam-top-down laser head configuration. The two beam approach is configured to have the beams 180° apart and the welding is done symmetrically. In such a case, the optical clip 100 should be fabricated of a weldable material, such as Kovar. Alternatively, the clip 100 may comprise invar, stainless steel, or nickel.

The attachment clip 100 allows for a coaxial type of alignment/attachment but utilizes a top-down configuration. The dimensions, location, and number of substantially horizontal feet 10 and substantially vertical side walls 20 are adjustable to suit the needs of various optical assemblies and/or components 200. The substantially vertical side walls 20 on the clip 100 allow for vertical movement of the optical component 200 above and below a desired plane. The substantially horizontal feet 10 provide mechanical stability for the clip 100 and also horizontal movement. The clip 100 allows for alignment and attachment without the need for additional tooling to keep the clip 100 in place during the attachment process. Depending on the geometrical shape and mass of the optical components 200 that the clip 100 supports, the locations of the substantially horizontal feet 10 and substantially vertical side walls 20 can be switched and otherwise adjusted to allow for optical mechanical stability. The attachment clip 100 allows for a method of coaxial type attachment without the need for a coaxial attachment system.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention.

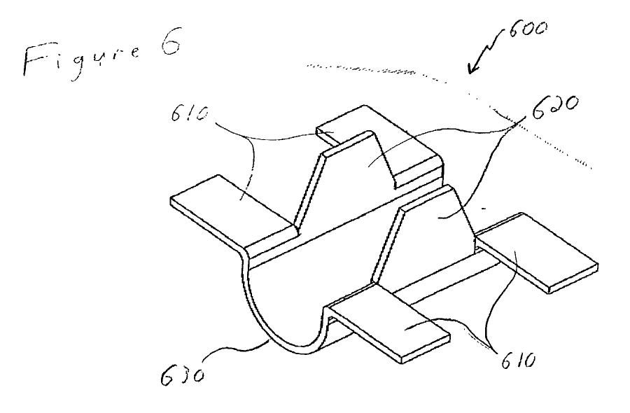

One such exemplary variation is shown in the perspective view of FIG. 6. FIG. 6 shows an optical clip 600 with vertical side walls 620, a plurality of horizontal feet 610, and a base portion 630. As shown, the vertical side walls 620 have a trapezoidal shape rather than the rectangular shape of previous embodiments. Alternatively, the vertical side walls 610 and/or the horizontal feet 610 may have a rounded/circular shape and/or other variations as would be readily apparent to one skilled in the art after reading this disclosure.

The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed:

1. An optical alignment device, comprising:
a base portion extending the length of said alignment device;
a substantially horizontal package mounting portion coupled to said base portion; and
a component retaining portion coupled to said base portion.

2. The optical alignment device of claim 1, wherein said component retaining portion is substantially vertical with respect to said substantially horizontal package mounting portion.

3. The optical alignment device of claim 1, wherein said component retaining portion is positioned at an angle less than 90° with respect to said substantially horizontal package mounting portion.

4. The optical alignment device of claim 1, wherein said component retaining portion is positioned at an angle more than 90° with respect to said substantially horizontal package mounting portion.

5. The optical alignment device of claim 1, wherein said substantially horizontal package mounting portion comprises a plurality of substantially horizontal feet, each of said feet extending substantially horizontally from a top edge of said base portion.

6. The optical alignment device of claim 5, wherein each of said substantially horizontal feet has a foot length in the range of about 0.5 mm to about 2 mm.

7. The optical alignment device of claim 5, wherein each of said substantially horizontal feet is formed by one of EDM machining, laser cutting, and stamping and press fitting.

8. The optical alignment device of claim 1, wherein said substantially horizontal package mounting portion is attached to a package.

9. The optical alignment device of claim 5, wherein each of said substantially horizontal feet is attached to a package.

10. The optical alignment device of claim 9, wherein each of said substantially horizontal feet is attached to a package by one of welding, epoxy, and solder.

11. The optical alignment device of claim 1, wherein said component retaining portion comprises a plurality of side walls, each of said side walls extending from a top edge of said base portion.

12. The optical alignment device of claim 11, wherein each of said side walls has a height in the range of about 0.5 mm to about 2 mm.

13. The optical alignment device of claim 11, wherein each of said side walls comprises an integral and vertical extension of said base portion.

14. The optical alignment device of claim 11, wherein each of said side walls is attached to said component by one of welding, epoxy, and solder.

15. The optical alignment device of claim 1, wherein said base portion has a substantially semicircular cross-section extending the length of said alignment device.

16. The optical alignment device of claim 15, wherein said base portion has a radius in the range of about 0.4 mm to about 2 mm.

17. The optical alignment device of claim 1, wherein said base portion has a substantially rectangular cross-section extending the length of said alignment device.

18. The optical alignment device of claim 1, wherein said base portion, said substantially horizontal package mounting portion, and said component retaining portion are formed as an integral unit.

19. The optical alignment device of claim 18, wherein said optical alignment device is cast.

20. The optical alignment device of claim 1, wherein said optical alignment device is made of a material comprising at least one of stainless steel, kovar, invar, and nickel.

21. A method of coaxial alignment, comprising the steps of:
positioning an optical component in an optical alignment device, the optical alignment device comprising:
a base portion extending the length of said alignment device;
a substantially horizontal package mounting portion coupled to said base portion; and
a substantially vertical component retaining portion coupled to said base portion;
attaching said substantially horizontal package mounting portion to a package; and
attaching said optical component to said substantially vertical component retaining portion.

22. The method of claim 21, further comprising a step of adjusting at least one of the position and alignment of said optical component within said optical alignment device, after attaching said substantially horizontal package mounting portion to a package.

23. The method of claim 21, wherein the substantially horizontal package mounting portion comprises a plurality of substantially horizontal feet, and wherein the step of attaching said substantially horizontal package mounting portion to a package comprises one of welding, epoxying, and soldering.

24. A coaxial alignment and attachment clip for single side optical component attachment, comprising:
a component loading section, said component loading section allowing said optical component to be adjustable by at least one of: (1) rotationally about a central axis of said optical component; (2) slidably along a length of said optical component; and (3) slidably along a height of said optical component; and
a package fixation section attached to said component loading section for fixing a package to the clip.

25. The coaxial alignment clip of claim 24, wherein said optical component is fixed in a non-adjustable position within said component loading section after properly aligning said optical component.

26. The coaxial alignment clip of claim 25, wherein said optical component is fixed to said component loading section via one of welding, epoxying, and soldering.

27. The coaxial alignment clip of claim 24, wherein said package fixation section is fixed to said package via one of welding, epoxying, and soldering.

28. The coaxial alignment clip of claim 24, wherein said optical component is rotationally adjustable about a central axis of said optical component.

29. The coaxial alignment clip of claim 24, wherein said optical component is slidably adjustable along a length of said optical component.

30. The coaxial alignment clip of claim 24, wherein said optical component is slidably adjustable along a height of said optical component.

31. The coaxial alignment clip of claim 24, wherein said optical component is (1) rotationally adjustable about a central axis of said optical component, (2) slidably adjustable along a length of said optical component, and (3) slidably adjustable along a height of said optical component.
